(19) United States
(12) Patent Application Publication
(10) Pub. No.: US 2026/0301102 A1
(43) Pub. Date: Oct. 1, 2026

(54) UNIVERSAL PROPERTY IDENTIFIERS FOR BULK MAILING

(71) Applicant: Bryan Barrios, New Orleans, LA (US)

(72) Inventor: Bryan Barrios, Thibodaux, LA (US)

(73) Assignee: Bryan Barrios, New Orleans, LA (US)

(21) Appl. No.: 19/094,533

(22) Filed: Mar. 28, 2025

(51) Int. Cl. G06Q 50/60; G06F 3/12; G06Q 10/0834; G06Q 10/1093

(52) U.S. Cl. CPC G06Q 50/60; G06F 3/1204; G06F 3/1243; G06F 3/1253; G06F 3/1287; G06Q 10/0834; G06Q 10/1097

(57) ABSTRACT

Methods, computer systems, and memory media for preparing instructions for printing a plurality of postage items. A computer system uploads an addressee data file responsive to first user input received via a graphical user interface (GUI). Further responsive to the first user input, the computer system automatically identifies a first city, state and street address from the addressee data file. A first universal property identifier (UPI) associated with the first city, state, and street address is identified in a second data file. A first column is identified in the addressee data file that contains the first UPI, and distinct entries in the first column are extracted to form a UPI list. Destination addresses are determined from the second data file that are associated with each UPI in the UPI list. Responsive to second user input, instructions are prepared for printing the destination addresses onto a plurality of postage items.

### FIELD

The present application generally relates to methods and systems for automatically producing and tracking custom mass mailings.

### DESCRIPTION OF THE RELATED ART

Many companies and governments send out bulk mailings to large numbers of recipients for various business, legal, and administrative purposes. The process of preparing and sending bulk mailings may be complicated by the fact that an uploaded addressee database is in an unstructured format, and further by the need to customize the content, delivery mechanism, and/or tracking procedures for the mailing materials for different recipients. Sending out bulk mailings to large numbers of recipients with United States Postal Service (USPS) Certified Mail and/or Return Receipt Requests is commonly used by local governments and political subdivisions prior to tax sale or property auction prescribed by law for the recovery of delinquent property tax. The process of preparing and sending bulk mailings to a large number of recipients typically takes a large amount of secretarial time and effort. Accordingly, improvements in the field are desirable.

### SUMMARY

Embodiments relate to systems and methods for preparing printing instructions and printing a plurality of postage items. The system includes a processor coupled to a non-transitory computer-readable memory medium. The system may include, or may be coupled to, a printer that is configured to receive the printing instructions and print the plurality of postage items according to the instructions. The processor may execute program instructions stored on the memory medium to create the printing instructions.

In some embodiments, a graphical user interface (GUI) is displayed on a display. Responsive to first user input, a prompt is displayed that is selectable to upload an addressee data file. The addressee data file may include a plurality of entries in a plurality of rows and a plurality of columns, wherein the entries are strings of text.

The processor may automatically identify a first city and a first state associated with the addressee data file, and identify a first row in the addressee data file that contains the first city and the first state. In some embodiments, a first street address is extracted from the first row.

In some embodiments a first universal property identifier (UPI) associated with the first city, the first state, and the first street address is identified in a second data file. In some embodiments, a first column in the addressee data file is identified that contains the first UPI.

In some embodiments, distinct entries in the matched column are extracted to form a UPI list of a plurality of UPIs. A plurality of destination addresses may be determined from the second data file, where each destination address of the plurality of destination addresses is associated with a respective UPI in the UPI list.

In some embodiments, responsive to second user input, printing instructions are transmitted from the processor over a transmission path to a printing processor of a printing device. The printing instructions may be instructions for printing the respective destination addresses associated with each of the plurality of UPIs onto respective ones of the plurality of postage items. The printing device may print the plurality of postage items responsive to receiving the printing instructions.

The techniques described herein may be implemented in and/or used with a number of different types of computing devices, including but not limited to desktop computers, laptops, cellular phones, tablet computers, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates a schematic diagram of a system for printing bulk mailings of a plurality of postage items, according to some embodiments;

FIG. 2 is a flowchart diagram illustrating a method for preparing instructions for printing a plurality of postage items, according to some embodiments;

FIG. 3A is an example of a graphical user interface (GUI) displaying a prompt to upload an addressee data file, according to some embodiments;

FIG. 3B is an example of a GUI displaying a prompt to upload a template file, according to some embodiments;

FIG. 3C is an example of a GUI displaying a selectable icon to pay for and print a plurality of postage items, according to some embodiments; and

FIGS. 4A-G illustrate a work flow diagram for preparing instructions for printing a plurality of postage items, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
Processing Element—refers to various elements or combinations of elements that are capable of performing a function in a device, such as a user equipment or a cellular network device. Processing elements may include, for example: processors and associated memory and circuitry, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system may update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks.

In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

### Automatic Bulk Mailings

Companies, corporations, universities, government entities, and other types of organizations often send large quantities of related mail to a plurality of recipients. As one example, for a tax lien or tax deed sale, certified mail may need to be sent to each of a large number of owners, co-owners, and/or other interested parties to the relevant property. Alternatively, a company may desire to send a particular mailing out to each of its employees, customers, or other types of individuals. A university may periodically send bulk mailings out to its faculty, staff, students, donors, or alumni, among other possible types of recipients. More broadly, any of a number of different types of organizations or individuals routinely send bulk mailings out to large numbers of recipients (e.g., potentially hundreds or even thousands of recipients at a time). Typically, formatting, printing, processing, mailing and tracking customized bulk mailings takes a large quantity of secretarial time and effort, increasing costs for the organization or individual. To address these and other concerns, embodiments herein present systems and methods for constructing a streamlined graphical user interface and underlying processing that allows a client to prepare and mail large quantities of custom bulk mailings quickly and easily.

A variety of types of individuals and organizations may utilize embodiments described herein to print customized bulk mailings. For simplicity, the entity that utilizes the described systems and methods to produce (i.e., produce printing instructions for) the customized bulk mailings will be referred to herein as the “client”, and the recipients of the customized bulk mailings will be referred to herein as “recipients” or “addressees.” Previous methodologies for producing custom bulk mailings may utilize significant time and expense, for a variety of reasons. For example, a client may have a list of addressees in a data file that is not in a standardized form, and a secretary or other individual may typically analyze the data file to determine which fields in the data file to print as specific components of each recipient's address. Further, the client may desire to customize the postage item for different recipients (e.g., a custom letter may be desired with different salutations and/or text for different recipients), which may typically involve a manual process of editing the postage item for each recipient. As another example, some types of mailings utilize tracking and/or delivery confirmation, which may be cumbersome to perform for a large number of mailings. Additionally, it may be desirable to redirect and resend undelivered and returned mail, either automatically or manually, to satisfy certain legal requirements. Embodiments herein address these and other concerns by presenting a streamlined graphical user interface that is useable for creating an arbitrarily large number of customized postage items rapidly, intuitively, and with a dramatically reduced level of effort by the client relative to previous implementations.

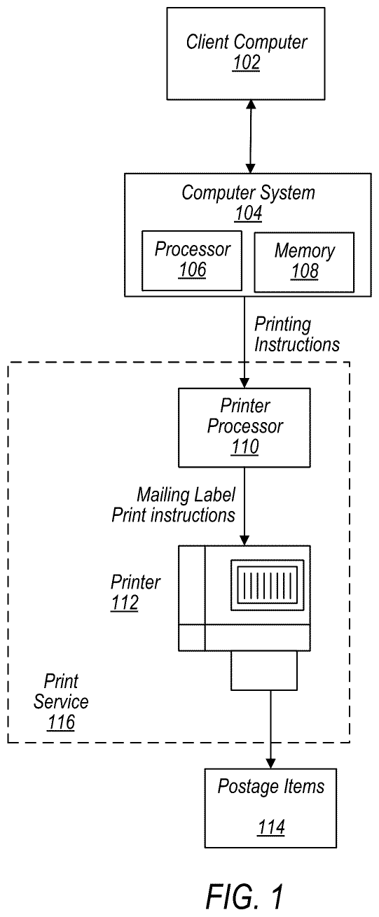

### FIG. 1—System for Printing Bulk Mailings

FIG. 1 depicts a schematic diagram of a system for printing bulk mailings of a plurality of postage items. In some embodiments, a computer system 104 may receive one or more files from a client (e.g., from a client's computer system 102), such as an addressee data file of the names and addresses of recipients of the bulk mailings, and/or a letter or template file to send with the bulk mailings, among other possibilities. The computer system 104 may further receive user input from the client to facilitate preparation of printing instructions for printing the plurality of postage items 114. The computer system 104 may send the printing instructions to a printer processor 110 of a printing service 116 to queue the plurality of postage items for printing by a printer 112. The printing service 116 may be a commercial printing service, or an in-house printing service operated by the owner of the computer system. The printer 112 then prints a respective address on each postage item, generates and prints tracking barcodes and postage on the postage items, and/or prints custom letters for each of the postage items 114. The printing service may be further configured to automatically fold the letters, insert them into their respective envelopes, seal the envelopes, (optionally) glue a green card to the envelopes (e.g., if the mail is being sent via certified mail), and/or capture an image of the final envelope for record-keeping. The plurality of postage items may be then sent to a postal service such as the United States Postal Service (USPS), FedEx™, or the United Parcel Service™ (UPS™), among other possibilities.

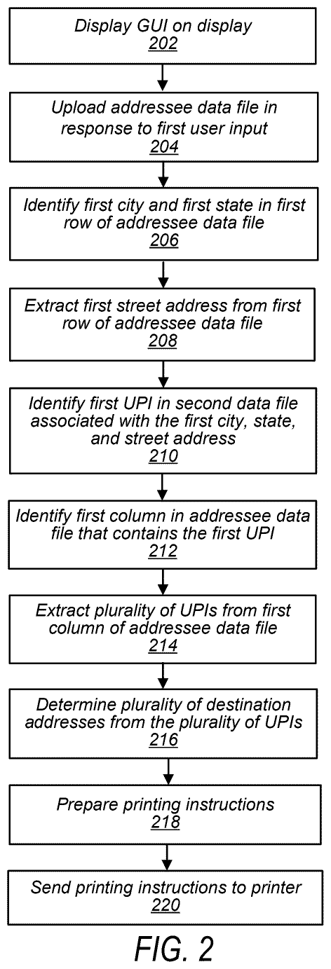

### FIG. 2—Flowchart for Preparing Printing Instructions

FIG. 2 is a flowchart diagram illustrating a method for preparing instructions for printing a plurality of postage items, according to some embodiments. In some embodiments, a non-transitory, computer-readable memory medium stores program instructions which, when executed by a processor of a computer system, cause a graphical user interface (GUI) to be displayed on a display. The executed instructions may receive and respond to user input via the GUI, and perform backend processing for performing the method steps described in reference to FIG. 2. In exemplary embodiments, the GUI is displayed through a webpage that is accessible by a client on their own personal computer system or other type of electronic device. For example, in some embodiments, a client may access a web page using a desktop computer, laptop, tablet, or user equipment (UE) device (e.g., a smart phone), among other possibilities, and the web page may display an interactive GUI useable for producing printing instructions, causing the printing and mailing of postage items, as described herein.

In some embodiments, the computer system executing the program instructions may be a server computer that sends instructions over the internet to display the GUI on the client's device, and the computer system may receive data (e.g., uploaded addressee data files, letter templates, etc.) and user input over the internet from the client's device to facilitate preparation of the printing instructions. Alternatively, in some embodiments the program instructions may be installable as an executable program on a personal computing device of the client. Once installed on the client's device, the program instructions may be executable to display the interactive GUI on the display of the client's device, receive user input to facilitate production of the printing instructions, and transmit the instructions over the internet or other transmission path to a printing service. In various embodiments, some of the elements of the scheme shown may be performed concurrently, in a different order than shown, or may be omitted. Additional and/or alternative elements may also be performed as desired. As illustrated, the method of FIG. 2 may operate as follows.

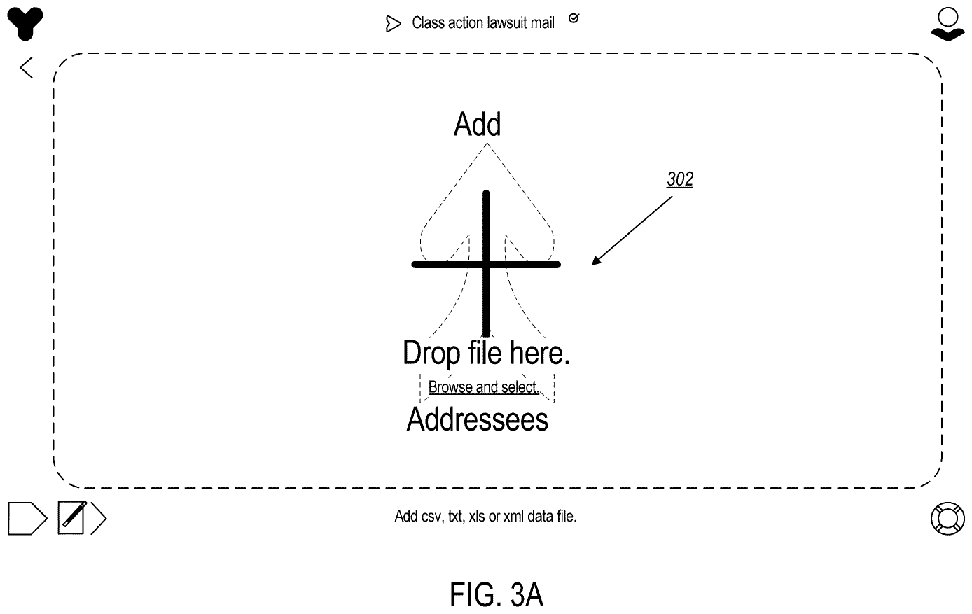

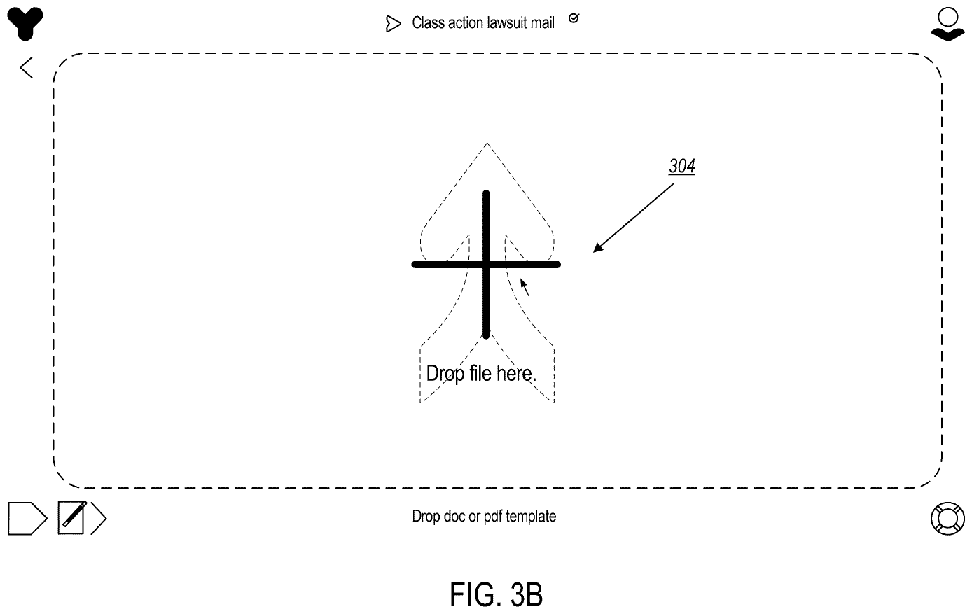

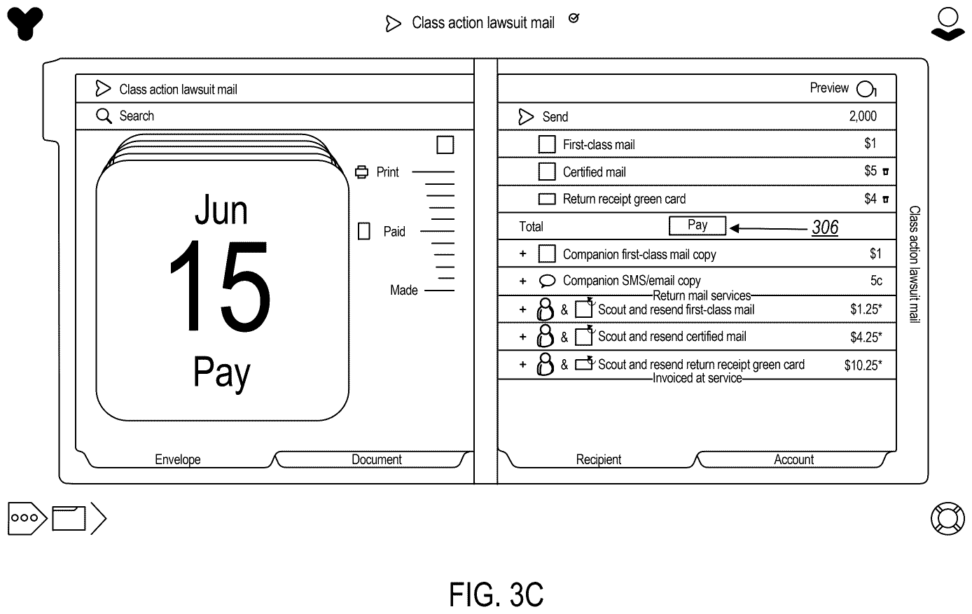

At 202, a GUI is displayed on a display. The GUI may be configured to receive first user input and second user input. For example, the GUI may include at least a first icon that is selectable to upload an addressee data file. An example GUI is displayed in FIG. 3A, where the GUI presents a prompt 302 configured to receive the first user input to upload an addressee data file. The addressee data file may be dragged and dropped onto the prompt to initiate the upload. The second user input may trigger the transmission of printing instructions to a printer device, after they are prepared and approved by the user.

At 204, the addressee data file is uploaded responsive to the first user input. The addressee data file may include a plurality of entries in a plurality of rows and a plurality of columns. Each entry may be a string of text (e.g., letters, numbers, and/or special characters). Each row may correspond to a different recipient (i.e., addressee) and each column may correspond to a different aspect of the recipients. In some embodiments, different rows of at least a subset of the plurality of rows correspond to different addressees, and different columns of at least a subset of the plurality of columns correspond to different address field types.

For example, there may be a column for each of a plurality of different address field types, such as first name, last name, address, address 2, city, state, and zip code of each recipient. More generally, the addressee data file may include any of a variety of types of information related to the recipients. For example, there may be a column corresponding to a numerical quantity for each addressee, such as their birthdays, money owed, stocks owned, or information related to a property or tax sale, among various other possibilities. In some embodiments, the addressee data file may be unstructured or otherwise not in a standard format.

Alternatively, in some embodiments, the recipients may each correspond to a different column, and the rows may denote the different aspects of each recipient. In these embodiments, it is understood that the methods described herein may be adapted such that instances of “row” are replaced by “column,” and vice versa.

At 206, a first row in the addressee data file is identified that contains a first city and a first state. The first city and the first state may be associated with the addressee data file. For example, in some embodiments, the first city and the first state may be identified from an internet protocol (IP) address from which the addressee data file is uploaded. For many bulk government mailings, the user who is preparing the printing instructions may be a government employee who is physically located in the city and state where the bulk mailings will be mailed. Accordingly, the city and state associated with the IP address from which the addressee data file is uploaded may be the same as the city and state of one or more addressees in the addressee data file. Alternatively, in some embodiments the first city and state may be determined to be the most frequently occurring city and state contained in the addressee data file. In some embodiments, an application programming interface such as Abstract API™ may be used to determine the first city and state. In some embodiments, such as for a full service client the first city and state may be determined directly from a data table within a file transfer protocol (FTP) server that is associated with the user account that uploaded the addressee data file.

However the first city and state are determined, the processor may identify a row in the addressee data file (i.e., the first row. Note that “first” simply distinguishes the row from other rows, and does not imply that the first row is the top row of the addressee data file) that contains this city and state combination.

At 208, a first street address is extracted from the first row of the addressee data file. For example, the entries in the first row may be analyzed to identify a street address.

At 210, a first universal property identifier (UPI) associated with the first city, the first state, and the first street address is identified in a second data file. The second data file may be a comprehensive database of property data for a particular region, such as a city, county, state or country. In some embodiments, the second data file may be an ATTOM™ data file. The second data file may include a plurality of property addresses (e.g., city, state, and street address), and each property address may be associated with a unique UPI.

At 212, a first column in the addressee data file is identified that contains the first UPI. Said another way, the processor may scan entries in the addressee data file until a match of the first UPI is found, and the column in which the match is found may be flagged.

At 214, distinct entries in the first column are extracted to form a UPI list of a plurality of UPIs. In some embodiments, extracting the distinct entries in the first column is only performed for rows that contain the first city and the first state. In other embodiments, all distinct (i.e., non-redundant) UPIs are extracted from the first column, and stored as a UPI list. In some embodiments, the addressee data file may be unstructured and/or may have multiple addresses listed for a single addressee. However, each UPI in the addressee may be uniquely associated with a particular destination address. Advantageously, identifying the UPI column in the addressee data file and extracting each distinct UPI in that column may provide an efficient method to identify each unique destination address for the plurality of postage items.

At 216, a respective destination address associated with each of the plurality of UPIs is determined from the second data file. For example, each UPI may be identified in the second data file, and the associated destination addresses may be extracted to form a destination address list.

In some embodiments, it may be determined that two different contact owner names are associated with a single destination address in the addressee data file. Responsive to this determination, a child row may be created in a local database that includes the second contact owner name. Instructions may then be prepared for printing a postage items addressed to each of the two contact owner names at the same destination address.

In some embodiments, the GUI displays an icon that is selectable via third user input to 1) display a prompt that is selectable to input a sender name for the plurality of postage items, 2) display a prompt that is selectable to input a date for sending the plurality of postage items; or 3) display a prompt to select a method for delivering the plurality of postage items. In some embodiments, the prompt displays one or more selectable methods for delivering the plurality of postage items including first-class mail, certified mail with an electronic return receipt, certified mail with a green card return receipt, emailed digital copy, and/or text digital copy.

In some embodiments, the GUI may present an icon that is selectable to allow a client to upload a template file and customize portions of the template for different recipients. An example of a GUI for uploading a template file is shown in FIG. 3B, in accordance with some embodiments. As illustrated, the GUI shown in FIG. 3B illustrates an icon 304 configured to receive user input to upload the template file. For example, the GUI may include an icon that is selectable to prompt the client to upload a template for the plurality of postage items. The user may upload a content template or select an existing template to generate letters. Templates may be of various files formats such as .pdf, word documents, or .html, and may include personalization. The content template may be a document template, a flyer, an advertisement template, or any of a variety of other types of content that may be mailed with the postage items. The system saves the template to be used anytime for the Send.

The computer system may upload the letter template responsive to the user input. After successfully uploading the template file, the GUI may automatically display the template and the addressee data file. In some embodiments, the processor may execute instructions to automatically analyze the template and the addressee data file to determine columns and/or strings in the addressee data file to associate with fields in the template file. For example, curly braces or another marker may be used in the template file to indicate fields that should be populated from the addressee data file (e.g., names, addresses, dates, etc.). The field may take a single value from the addressee data file that is the same across all of the postage items (e.g., a date by which a response is solicited), or the field may take a variable value for each of the postage items (e.g., a destination address). After making an association between columns/strings in the addressee data file and fields in the template, the GUI may be configured to display an example document with the fields populated with the associated data from the addressee data file. The user may be able to modify the data, as appropriate, by a “spin to select” input (i.e., to select through different columns of the addressee data file), or through a “type-to-enter” input to manually replace the field with the desired string.

In some embodiments, the computer system may be configured to receive user input to select a portion of the text in the displayed letter template and associate the selected text with a particular column of the addressee data file. The client may associate the selected portion of text and the particular column of the addressee data file by dragging and dropping the selected text onto the column, dragging and dropping the column onto the selected text, or by performing another type of user input, in various embodiments. The computer system may prepare the printing instructions to, for each of the plurality of postage items, replace the selected portion of text with respective entries in the particular column. As one example, a client may select a portion of text by highlighting the addressee name (e.g., “Sherry Miller”) in the template letter, and the client may drag and drop this name onto a “Name” column of the addressee data file. The computer system may then prepare printing instructions in which, for each postage item, the selected text in the template letter is replaced with a different respective name from the “Name” column of the addressee data file, for each of the plurality of postage items. More generally, the client may select any portion of text from the template letter and associate it with any column of the addressee data file, to auto-populate the selected portion of text with respective entries in the associated column of the addressee data file for each of the plurality of postage items.

At 212, at least in part in response to receiving the second user input via the GUI, printing instructions are prepared for printing respective destination addresses associated with each of the plurality of UPIs onto respective ones of the plurality of postage items. The user may have the opportunity to review and edit the postage items. FIG. 3C is an example of a GUI displaying a selectable icon 306 to pay for and print a plurality of postage items, according to some embodiments. After confirming that the postage items are prepared correctly, a “Pay” button may be displayed, which may be selected to provide payment, and automatically prepare and send the printing instructions to a printing device, as one example. The illustrated GUI in FIG. 3C also illustrates a variety of options for different types of mailing, and their associated costs.

At 214, the instructions are transmitted over a transmission path to a printing processor of a printing device to print the plurality of postage items. In some embodiments, the printing instructions are stored in a non-transitory computer-readable memory medium. In some embodiments, the printing device prints respective ones of the destination addresses onto respective ones of the postage items, responsive to receiving the printing instructions. In some embodiments, the printing device prints a plurality of documents according to the template files that have been populated with data from the addressee data file.

### Additional Description

The following paragraphs provide additional description of methods and systems for preparing printing instructions for a plurality of postage items, according to various embodiments.

### Definition of Terms

Abstract application programming interface (API) is a service that offers an internet protocol (IP) Geolocation API that allows you to track and retrieve information associated with an IP address.

ATTOM aggregates property data from various public and private sources, including county assessor offices, tax records, and other real estate databases.

Relational Database Service (RDS) is a cloud-based relational database service

UPI stands for Unique Property Identifier, also known as Parcel ID or Parcel Identifier.

Mail-Ready is a print-ready single doc or pdf file comprising all documents.

Merge-Ready is a single doc or pdf template with variable data inside curly braces {}.

Data file refers to the record kept by a local government or taxing authority of property owners who have failed to pay their property taxes by the due date.

OCR (Optical Character Recognition) is a technology that allows computers to read text from images or scanned documents.

CASS (Coding Accuracy Support System) is a USPS certification program that validates address standardization and correction software. It ensures accurate address data for efficient mail delivery by verifying against the USPS database.

Symple Progress ID indicates how the file was received—whether through Send, Search, Sell, or another method—and identifies the client it came from.

Symple Property ID is a combination of the 10-digit FIPS code and the UPI. This combination enables identification of the state, county, and city from the FIPS code to then pinpoint the exact property using the UPI.

Mapbox is a tool that developers can use to create custom maps and location-based experiences in their applications.

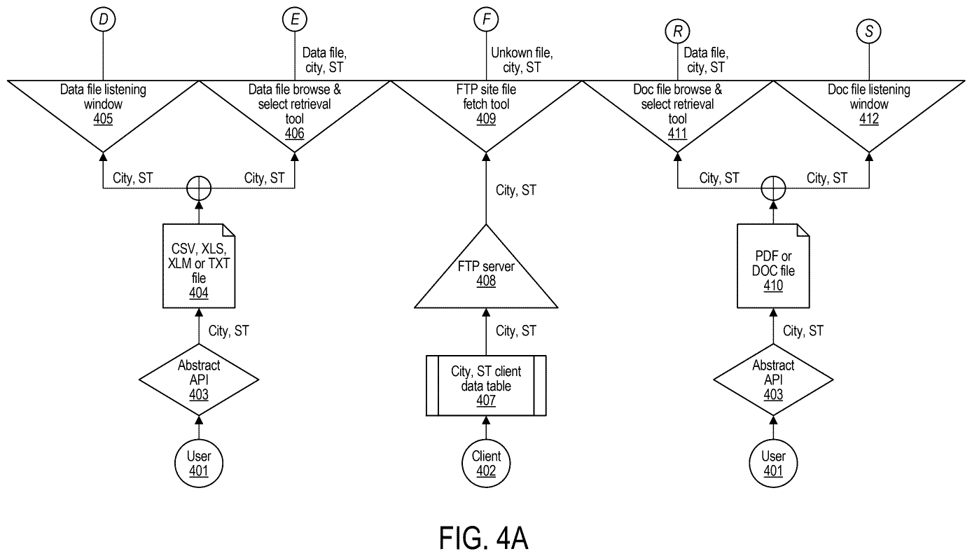

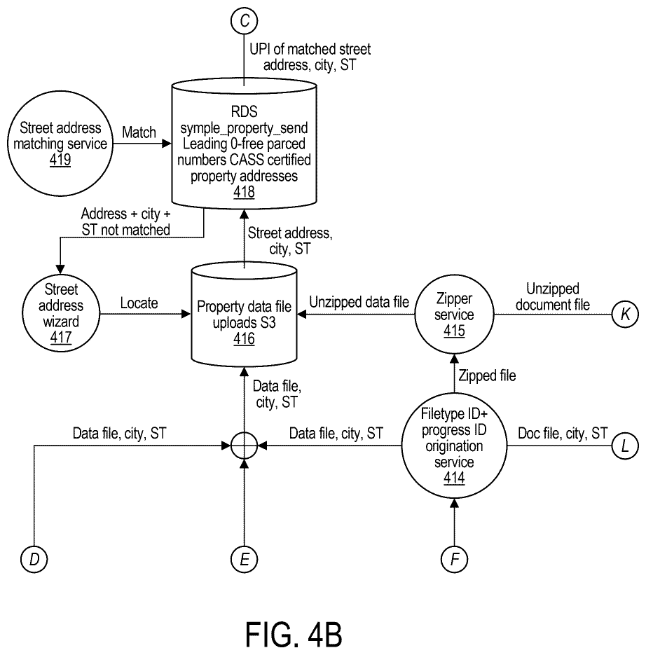

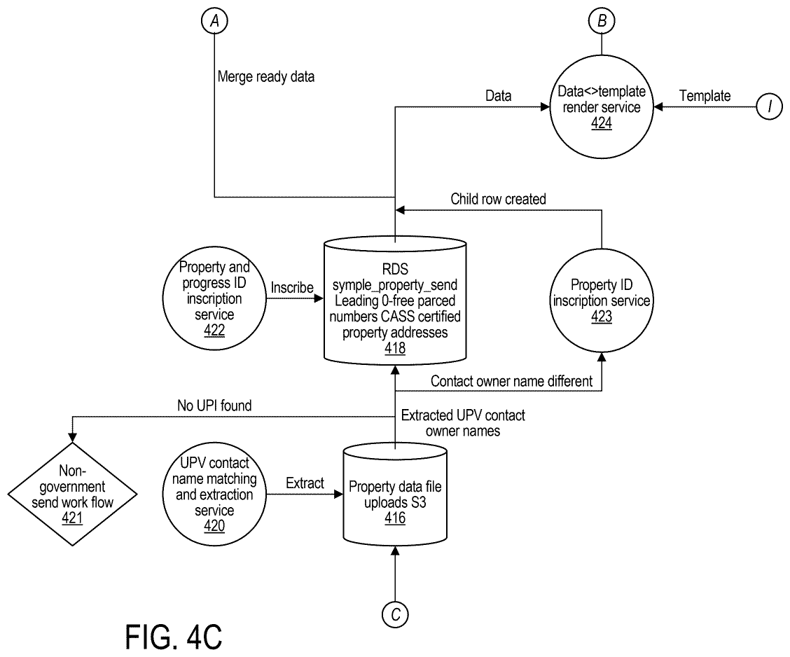

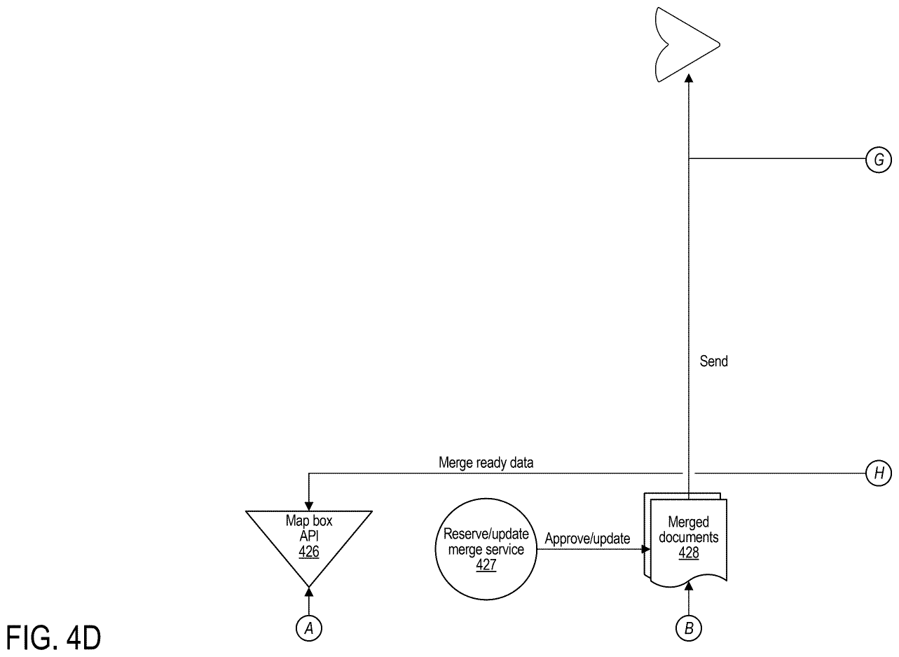

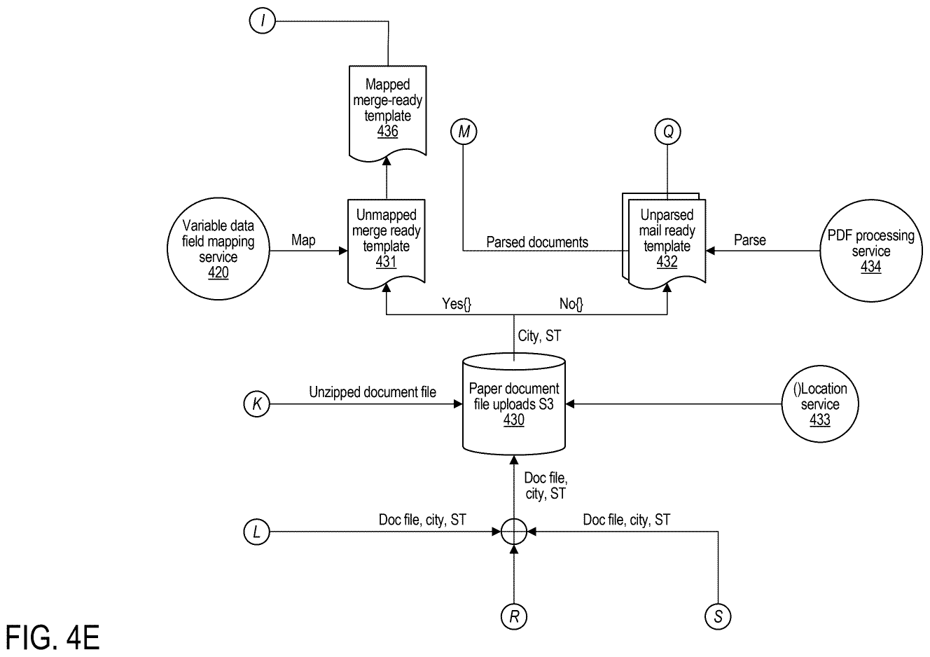

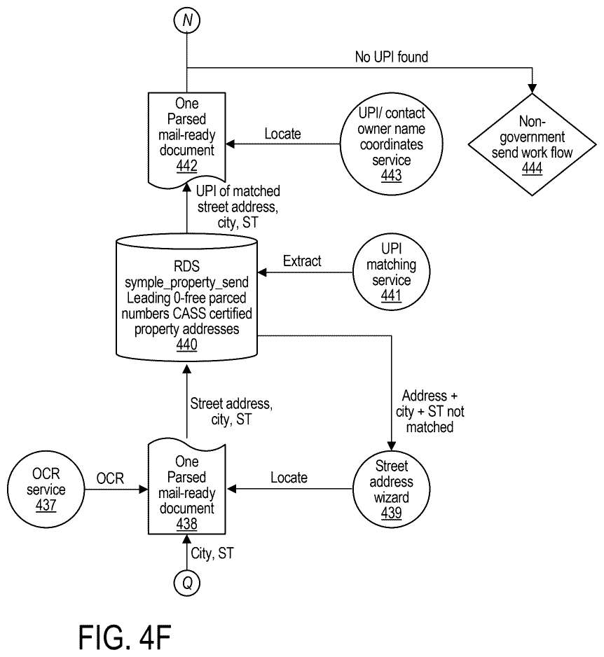

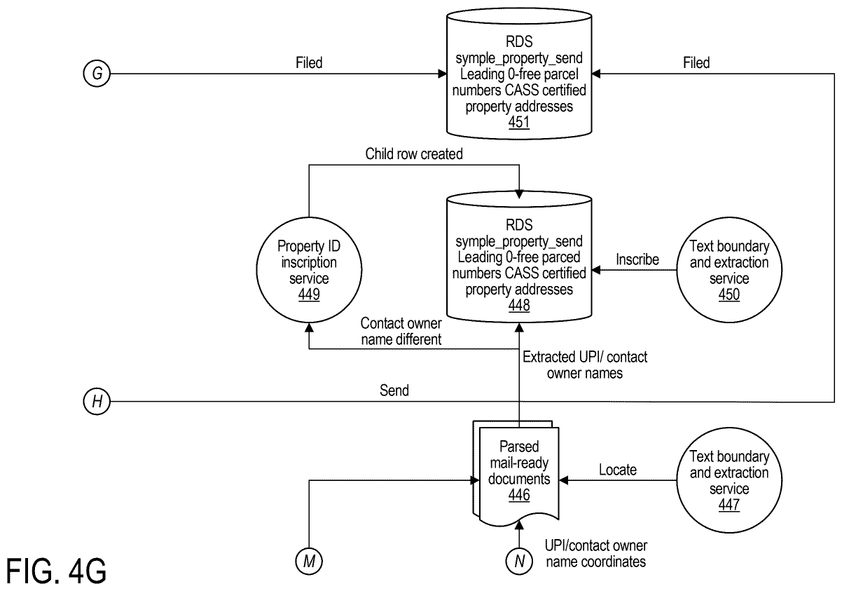

### FIGS. 4A-G —Flow Diagram for Preparing Printing Instructions

FIGS. 4A-G illustrate a work flow diagram for preparing instructions for printing a plurality of postage items, according to some embodiments. Note that the nodes in FIGS. 4A-G often denote software modules, which are executable by a processor for a particular functional purpose, as described.

In some embodiments, the client uploads an addressee list (e.g., an addressee data file), which may be a data file such as a .cvs or .xls file, among other possibilities. In some embodiments, other client systems such as Microsoft Office™ plugins may be integrated into the upload process.

In some embodiments, an Application Programming Interface (API) 403 may be used to determine the source location of files uploaded via drag-and-drop. The API typically provides detailed location data, but only the city and state may be extracted. For files received through a file transfer protocol (FTP) site, which indicates a full-service client, the city and state may be retrieved directly from the Client Data Table 407 within the FTP server 408. The extracted city and state may be the city and state associated with the IP address that uploaded the addressee data file. The city and state may be extracted, rather than the county, because while the same street name can appear multiple times within a county, it is unlikely to repeat within a single city.

In some embodiments, an uploaded addressee data file may be monitored through designated listening windows, to check the file type, and route it to an appropriate pipeline. The listening window may be a Data File Listening Window 405 that receives data files in CSV, TXT, XML, and XLSX formats, a Data File Browse & Select Retrieval Tool 406 that enables the user to browse and select a data file from their computer, an FTP Site File Fetch Tool 409 that receives data files, document files or a ZIP file that could contain both from a FTP window; a Doc File Browse & Select Retrieval Tool 411 that enables the user to browse and select a doc file from their computer, or a Doc File Listening Window 412 that receives document files in PDF and DOC formats, among other possibilities.

In some embodiments, once the file type is identified, the addressee data file (along with the city and state) may be uploaded to a cloud-based object storage service (e.g., to the Property Data File Uploads 416). Similarly, document files (along with city and state) may be uploaded to a cloud-based object storage service such as the Paper Document File Uploads 430.

In some embodiments, when the users upload a ZIP file through the FTP window, the system forwards the ZIP file to the Zipper Service 415, which unzips its contents, determines the file type, and uploads to its respective cloud-based object storage service.

### Finding Curly Braces Using {} Location Service

In some embodiments, “{} Location Services” 433 checks the uploaded document for variable data. If the document contains curly braces {}, it is classified as a template with variable data and sent to the Merge-Ready flow starting at module 431. If not, it is considered a Mail-Ready document and routed to its respective flow starting at module 432.

### Locating Street Address Using Street Address Wizard (saw)

After the data file is uploaded to a cloud-based object storage service, a Street Address Wizard 417 may scan the data file to locate standard United States Postal Service (USPS) street suffixes. Since a data file often contains thousands of records, SAW isolates a single street or road by searching for suffixes like Ave, Blvd, Ct, etc. Once a street is located, it pairs the street address with the city and state information obtained from the Abstract API.

### Standardizing the Address

In some embodiments, the street address located by SAW is moved, along with the city and state, to a symple_property_send table in RDS. The address may be “cleaned up” by removing any unnecessary characters such as leading zeros, hyphens, periods, or other symbols not typically used in street addresses. The address may be corrected and standardized using a Coding Accuracy Support System (CASS)-Certified software. CASS is a USPS certification program that validates address standardization and correction software. It ensures accurate address data for efficient mail delivery by verifying against the USPS database.

CASS-Certified software may be used to standardize addresses (eg, abbreviating street names, correcting ZIP codes), verify an address against the USPS database, correct errors in addresses, and add missing information (e.g., like the correct 5-digit zip code +four digits).

In some embodiments, a Street Address Matching Service 419 matches the street address, city, and state from the symple_property_send table by comparing them against ATTOM's records, or records in another standardized address database. When a match is found, the corresponding UPI may be retrieved. In some embodiments, the uploaded addressee data file may then be analyzed to identify the UPI's position within the same row that the SAW used to locate the street address.

ATTOM contains over 155 million property records, which represent the distinct properties in the United States. Since ATTOM sources its data from the same assessor as the jurisdictions, the UPI will always match.

In some embodiments, if street address, city and state don't match, SAW identifies another street address in the data file, pairs it with city and state, and restarts the matching process.

### Extracting Upi Using Upi/contact Name Matching & Extraction Service

In some embodiments, once a UPI is identified in the data file, a UPI/Contact Name Matching and Extraction Service locates additional UPIs within the same column across subsequent rows and extracts both the UPI and Contact Owner Names.

### Inscribing Ids With Property and Progress Id Inscription Service

Before importing the extracted data into the symple_property_send table, the Property and Progress ID Inscription Service 422 assigns a unique ID to each record.

With the assigned ID, it may be identified which records from the data file should be processed for specific services, e.g., mailing, title abstracting, or any other step in the process leading up to the collection of taxes such as property taxes.

If the contact owner name has changed, a child row may be created in the database under the parent row, indicating the updated information. Since this should be mailed, this ensures it is sent to the new owner. This may happen if ATTOM hasn't updated its data yet—specifically, in the time between when the Assessor sent the data to the collector and when the collector uploads the addressee data file.

### Mapping Variable Data Using Variable Data Field Mapping Service

In some embodiments, after receiving an unmapped Merge-Ready template 431, the Variable Data Field Mapping Service 420 identifies and maps the variable data within it.

The mapped Merge-Ready template 436 may then be sent to a Data<>Template Render Service 424, which replaces the template's variable data with the corresponding data extracted from the addressee data file, which may be rendered and displayed in the GUI.

### Editing Content Using Review/update Merge Service

The Review/Update Merge Service allows users to review, edit, update, and approve the merged data from the GUI. When a user changes something, those changes are reflected in the database in real time. Once approved, the merged documents are ready to be Sent.

### Presenting Data Using Mapbox Api

The owner name, property address, status of the mail, and other related information may be plotted on an interactive map using Mapbox API.

### Filing Data on RDS

We file the UPI, Contact Owner Names, Property Address, Tax Information in our symple_paper_send table in our RDS.

### Mail-ready Flow

A Mail-Ready file is one file that may be parsed into individual documents that the user is sending. The basic difference from Merge Ready flow is the UPI is obtained from the paper from each document, and not from the data file. For mail-ready documents, users may upload a single large document containing multiple notices. The {} Location Service may scan for curly braces {} in the document, and when none are found, the document is routed to the Mail-Ready Pipeline. The PDF Processing Service 434 may then parse all the pages and separates them into individual documents.

The system may extract one notice from the single document, and extract text from it using an Optical Character Recognition (OCR) service 437. Then, the Street Address Wizard 439 locates the street address within the text and combines it with city and state information retrieved from Abstract API. From the thousands of notices in a mail-ready file, a single notice may be processed to establish the pattern.

### Locating Coordinates Using Upi/contact Owner Name Coordinates Service

Now that we've matched the street address, we take the UPI associated with it. Our UPI/Contact Owner Name Coordinates Service locates the coordinates of that UPI in that parsed Mail-Ready Document. If the UPI cannot be located, the document is routed to a Non-Government Send Work Flow 444.

### Extracting Texts Using Text Boundary and Extraction Service

The Text Boundary and Extraction Service 447 utilizes coordinate-based text extraction, applying the boundary coordinates established in the first document to subsequent documents to retrieve text from the corresponding spatial regions, targeting the expected UPI location.

### Inscribing Ids With Property Id Inscription Service

In some embodiments, the UPI/Contact Owner Names are extracted and stored in a RDS database. We then assign Property IDs and Progress IDs to these extracted UPIs, enabling us to link each document to its corresponding property in our database.

If the Contact Owner Name has changed, a child row may be created in our database under the parent row, indicating the updated information. Since this is to be mailed, this ensures it is sent to the new owner.

### Filing Data on RDS

We file the UPI, Contact Owner Names, Property Address, Tax Information in our symple_paper_send table in our RDS.

### Data Annotation

In some embodiments, .pdf data may be read and modified into a compatible format (e.g., a spreadsheet file). Letter data delimiter may be identified and annotated for pipeline processing. The data may be split and merged based on business rules, or custom split rules. Letter annotations may be identified to split a single file into multiple recipient letters. Splitting logic may be automatically detected based on the number of pages or on unique patterns. Custom delimiters may be applied to programmatically define the splitting and merging of letter files. Data integration may be performed with CSV (e.g., XLS-to-CSV), to insert custom external data onto source letter data, and pull data from CSV or XLS to a custom build letter. PDFs and Word files may be regenerated based on programmatic data, and PDF and Word data may be extracted and stored onto a platform database.

It is well understood that the use of personally identifiable information should follow privacy policies and practices that are generally recognized as meeting or exceeding industry or governmental policies for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement a method, e.g., any of the various method embodiments described herein (or, any combination of the method embodiments described herein, or, any subset of any of the method embodiments described herein, or, any combination of such subsets).

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer-implemented method for printing a plurality of postage items, the method comprising:
displaying a graphical user interface (GUI) on a display, wherein the GUI is configured to receive first user input and second user input;
responsive to the first user input, by a processor coupled to a non-transitory computer-readable memory medium:
uploading an addressee data file, wherein the addressee data file comprises a plurality of entries in a plurality of rows and a plurality of columns, wherein the entries comprise strings of text;
identifying a first city and a first state associated with the addressee data file;
identifying a first row in the addressee data file comprising the first city and the first state;
extracting a first street address from the first row;
identifying, in a second data file, a first universal property identifier (UPI) associated with the first city, the first state, and the first street address;
identifying a first column in the addressee data file that contains the first UPI;
extracting distinct entries in the first column to form a UPI list of a plurality of UPIs; and
determining, from the second data file, a plurality of destination addresses, wherein each destination address of the plurality of destination addresses is associated with a respective UPI of the plurality of UPIs; and
responsive to the second user input, transmitting, from the processor over a transmission path to a printing processor of a printing device, printing instructions for printing the respective destination addresses associated with each of the plurality of UPIs onto respective ones of the plurality of postage items.

2. The method of claim 1,
wherein extracting the distinct entries in the first column is only performed for rows that contain the first city and the first state.

3. The method of claim 1, further comprising:
printing, by the printing device responsive to receipt of the instructions, respective ones of the destination addresses onto respective ones of the postage items.

4. The method of claim 1,
wherein identifying the first city and the first state associated with the addressee data file comprises one of:
identifying the first city and the first state from an internet protocol (IP) address from which the addressee data file is uploaded, or extracting the first city and the first state from a database associated with a user account of the addressee data file.

5. The method of claim 1,
wherein identifying the first city and the first state associated with the addressee data file comprises determining a most frequently occurring city and state from the addressee data file.

6. The method of claim 1, further comprising:
responsive to third user input, uploading a template file; and
for each of the plurality of destination addresses, replacing variable data in a respective instance of the template file with data associated with the respective destination address.

7. The method of claim 6, further comprising:
transmitting, from the processor over the transmission path to the printing processor of the printing device, instructions for printing the respective instances of the template file.

8. The method of claim 1, further comprising:
determining that a first contact owner name associated with a first destination address of the plurality of destination addresses in the addressee data file is different from a second contact owner name associated with the first destination address in the second data file; and
responsive to determining that the first and second contact owner names are different, creating a child row in a local database comprising the second contact owner name.

9. The method of claim 1,
wherein the GUI further comprises a first icon, wherein the method further comprises:
responsive to third user input selecting the first icon:
displaying a prompt that is selectable to input a sender name for the plurality of postage items;
displaying a prompt that is selectable to input a date for sending the plurality of postage items; or
displaying a prompt to select a method for delivering the plurality of postage items.

10. The method of claim 9,
wherein the prompt displays one or more selectable methods for delivering the plurality of postage items, wherein the one or more selectable methods include one or more of:
first-class mail;
certified mail with an electronic return receipt;
certified mail with a green card return receipt;
emailed digital copy; and
text digital copy.

11. The method of claim 1,
wherein different rows of at least a subset of the plurality of rows correspond to different addressees, and
wherein different columns of at least a subset of the plurality of columns correspond to different address field types.

12. A non-transitory computer-readable memory medium comprising program instructions which, when executed by a processor, cause a computer system to:
display a graphical user interface (GUI) on a display, wherein the GUI is configured to receive first user input and second user input;
responsive to the first user input, by the processor:
upload an addressee data file, wherein the addressee data file comprises a plurality of entries in a plurality of rows and a plurality of columns, wherein the entries comprise strings of text;
identify a first city and a first state associated with the addressee data file;
identify a first row in the addressee data file comprising the first city and the first state;
extract a first street address from the first row;
identify, in a second data file, a first universal property identifier (UPI) associated with the first city, the first state, and the first street address;
identify a first column in the addressee data file that contains the first UPI;
extract distinct entries in the first column to form a UPI list of a plurality of UPIs; and
determine, from the second data file, a plurality of destination addresses, wherein each destination address of the plurality of destination addresses is associated with a respective UPI of the plurality of UPIs; and
responsive to the second user input, transmit, from the processor over a transmission path to a printing processor of a printing device, printing instructions for printing the respective destination addresses associated with each of the plurality of UPIs onto respective ones of the plurality of postage items.

13. The non-transitory computer-readable memory medium of claim 12,
wherein extracting the distinct entries in the first column is only performed for rows that contain the first city and the first state.

14. The non-transitory computer-readable memory medium of claim 12,
wherein identifying the first city and the first state associated with the addressee data file comprises one of:
identifying the first city and the first state from an internet protocol (IP) address from which the addressee data file is uploaded, or extracting the first city and the first state from a database associated with a user account of the addressee data file.

15. The non-transitory computer-readable memory medium of claim 12,
wherein identifying the first city and the first state associated with the addressee data file comprises determining a most frequently occurring city and state from the addressee data file.

16. The non-transitory computer-readable memory medium of claim 12, wherein the program instructions are further executable to cause the computer system to:
responsive to third user input, upload a template file; and
for each of the plurality of destination addresses, replace variable data in a respective instance of the template file with data associated with the respective destination address; and
transmit, from the processor over the transmission path to the printing processor of the printing device, instructions for printing the respective instances of the template file.

17. The method of claim 12, wherein the program instructions are further executable to cause the computer system to:
determine that a first contact owner name associated with a first destination address of the plurality of destination addresses in the addressee data file is different from a second contact owner name associated with the first destination address in the second data file; and
responsive to determining that the first and second contact owner names are different, create a child row in a local database comprising the second contact owner name.

18. The non-transitory computer-readable memory medium of claim 12, wherein the program instructions are further executable to cause the computer system to:
responsive to a determination that the first city, state and street address are not comprised within the second data file:
identify a second row in the addressee data file comprising the first city and the first state;
extract a second street address from the second row;
identify, in a second data file, a second UPI associated with the first city, the first state, and the second street address. identify a second column in the addressee data file that contains the second UPI; and
extract distinct entries in the second column to form the UPI list of the plurality of UPIs.

19. The non-transitory computer-readable memory medium of claim 12, wherein the program instructions are further executable to cause the computer system to:
determine that the first UPI is not contained in the addressee data file; and
responsive to determining that the first UPI is not contained in the addressee data file, prepare the printing instructions according to a non-governmental send workflow.

20. An apparatus, comprising:
a processor configured to execute instructions to:
display a graphical user interface (GUI) on a display, wherein the GUI is configured to receive first user input and second user input;
responsive to the first user input, by the processor:
upload an addressee data file, wherein the addressee data file comprises a plurality of entries in a plurality of rows and a plurality of columns, wherein the entries comprise strings of text;
identify a first city and a first state associated with the addressee data file;
identify a first row in the addressee data file comprising the first city and the first state;
extract a first street address from the first row;
identify, in a second data file, a first universal property identifier (UPI) associated with the first city, the first state, and the first street address;
identify a first column in the addressee data file that contains the first UPI;
extract distinct entries in the first column to form a UPI list of a plurality of UPIs; and
determine, from the second data file, a plurality of destination addresses, wherein each destination address of the plurality of destination addresses is associated with a respective UPI of the plurality of UPIs; and
responsive to the second user input, transmit, from the processor over a transmission path to a printing processor of a printing device, printing instructions for printing the respective destination addresses associated with each of the plurality of UPIs onto respective ones of the plurality of postage items.
